(19) United States
(12) Patent Application Publication
(10) Pub. No.: US 2005/0071233 A1
(43) Pub. Date: Mar. 31, 2005

(54) Payment card and method

(76) Inventors: Petter Nemeth, Oslo (NO); Tommy Lind, Oslo (NO)

Correspondence Address: LADAS & PARRY LLP, 224 SOUTH MICHIGAN AVENUE, SUITE 1200, CHICAGO, IL, 60604, US

(21) Appl. No.: 10/505,371

(22) PCT Filed: May 15, 2002
(86) PCT No.: PCT/NO02/00174

(30) Foreign Application Priority Data
Feb. 22, 2002 (NO) 2002-0860

(51) Int. Cl. G06F 17/60

(52) U.S. Cl. 705/18

(57) ABSTRACT

The invention concerns a payment system for payment of goods and services by using a prepaid card. The card comprises a concealed code and an activation code, and the card must be activated before use on a point of sale for the card by reading the activation code in a card reader on the point of sale. The activation code is transmitted to an offeror of the prepaid card together with an ID for the point of sale, and when paying for a commodity/service from a service provider, the concealed code must be transmitted together with the ID of the service provider to the card provider for thereby causing purchase of the service. The card and the payment solution is especially adapted to use for payment of goods and services which can be bought over Internet.

The invention concerns a method and a system for prepayment of online goods and services by using a prepaid card. Especially, the invention concerns a system for secure payment of goods, services and content on Internet.

### BACKGROUND

Today there exists payment solutions for goods and services which are sold through web sites. The web sites can charge for goods/services through the mobile phone to a user, through a credit card (example given Euro card, American Express) or registered payment cards (example given Visa) or in that the user has connected to an IPP (Internet. Payment Provider) where the user must register and on his own arrange for filling up the account. Many users have today also a threshold for shopping on the Internet, as they feel a risk by providing their payment card number and personal information on the Internet and many dare therefore not shop with their credit cards in fear of being swindled. By using a payment solution where the customer may put small shopping on his/her cell phone bill, it is also a problem that the cell phone bill shall be paid by others, example given an employer, which then shall not be charged for the users Internet shopping. By opening an account at an IPP the user must also provide personal information. In today's system it is also expensive for the web sites to charge for simple services which shall only cost small amounts (example given 10 NOK).

Accordingly it exists a need for a payment solution to be able to charge for its good, services and its content in a simple and cheap way for both online service providers and customers, and where the customer may keep his/her anonymity and avoids thorough registering to be able to buy a commercial goods or service.

### SUMMARY OF THE INVENTION

The present invention offers a solution to the problem provided above by in a first aspect a method for payment of goods, services and content by use of a prepaid card where the card comprises a concealed code and an activation code. The card is activated at a point of sale of the card by reading of the activation code in a card reader on the point of sale. The activation code is transmitted to an offeror of the prepaid card together with an ID for the point of sale, and when the card is used for payment of a commodity/service from a service provider, the concealed code is sent together with the ID for the service provider to the card provider for thereby bringing about purchase of the service.

The invention provides also in another aspect a system for prepayment of goods and services comprising a prepaid card, where the card comprises a concealed code to be used by a buyer of the card for authenticating when electronically shopping goods and services, and an activation code. The system further comprises a card reader for reading of activation code on the card on a point of sale for the card, and where the activation code is transmitted to a central system for a offeror of the prepaid card together with an ID for the point of sale, and an electronic service provider, where the service provider sends the concealed code from a buyer of a service at the service provider together with the ID of the service provider, to the central system of the card offeror for thereby causing payment of the service from the service provider.

The activation of the card preferably takes place in that the activation code is a bare code in that the card is read in a bare code reader. Activation causes that an account opens for the buyer of the card at the card offeror, with an amount corresponding to the prepaid amount. The concealed code can be covered by a thin opaque layer which must be scratched off by a buyer of the card. When the card is used as a payment means, the card offeror controls that the card is activated, authenticates the concealed code and the service provider ID, and controls that the balance of the account is greater or equal to the cost of the purchase of the service, before purchase of the service can take place. This control and authentication preferably take place by queering against the database of the card offeror stored on a database server communicating with the transaction server.

In a preferred embodiment the IP-address for the service provider and at least one unique password is used as the service provider ID. In another embodiment the ID for the point of sale may however be the phone number of the point of sale and a unique password for the point of sale. The point of sale communicates then with the central systems through the telephone network and/or Internet. The central systems comprise in a preferred embodiment a transaction server which has stored thereon functions for logic and procedures, and a database server comprising a database with data for the prepaid cards, point of sales and service providers, and a firewall between the transaction server and the database server, and where queries against the database are controlled by the transaction server. The database comprises further a table stored for each card, where each table comprises the concealed code, the activation code, whether the card is activated and the balance on the account pertaining to the card, and a table of point of sales and service providers with pertaining ID. The invention is defined in the appended patent claims.

The payment solution as stated above provides a secure and simple solution with possibility for anonymity for the purchaser of the card and thereby the purchaser of goods/services on electronic sites/interactive trading sites. The trade is settled in cash, which provides cost control for the purchaser when trading in these trading places. For the interactive trading places which are connected to this payment solution, this solution will also provide less loss on debts, and the possibility of charging the customer in advance. Such a payment solution where the customer does not need to use a credit card or other payment card connected to an ordinary bank account, would probably also contribute to expanding the existing market for the trading place.

The security is also taken care of by the number of codes and passwords for the different actors in this payment solution. Each card has a unique activation code and a concealed code which the user uses for payment of goods/services/content. Also the ID of the point of sale and the password for the point of sale. And at last, each web site wanting that the customers shall be able to use this payment solution, has their unique passwords which are automatically updated on a regular basis, usually every day. The payment solution also demands information on the IP of the web site and IP of the user, if the web site and the user are connected to Internet.

### SHORT DESCRIPTION OF THE DRAWINGS

Embodiments of the invention will now be described with reference to the following drawings, where:

FIG. 1A-1C show a payment card according to an embodiment of the invention;

FIG. 2 shows a concept sketch regarding the payment solution according to an embodiment of the invention;

FIG. 3 is a flow chart for activation of the payment card in FIG. 1A-1C for use in the payment solution in FIG. 2 according to an embodiment of the invention;

FIG. 4 is a flow chart showing an online payment process by the use of the payment card according to an embodiment of the invention;

FIG. 5 is a draft showing cash flow in the payment system according to an embodiment of the invention;

FIG. 6 shows a view of the payment system according to an embodiment of the invention where the different actors are connected to Internet; and

FIG. 7 shows a view of tables in the database according to an embodiment of the invention.

### DETAILED DESCRIPTION OF THE INVENTION

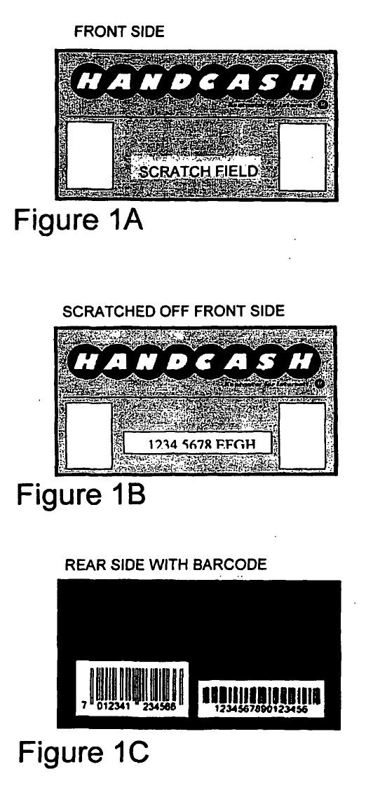

FIG. 1A-1C show an embodiment of a prepaid card. The card has assigned a value (not shown) corresponding to the amount a purchaser must pay for the card. The amount can vary from 50 kroner to several thousand kroner. On the card it is applied a unique activation code, which in FIG. 1C is a bar code on the backside of the card, but this unique activation code may also example given be a magnetic stripe. The activation code is used when activating the card on a point of sale for the card by reading the code in a suitable card reader, example given a bar code reader or a magnetic card reader. This will be further explained later. In addition it is a hidden code on the card which in FIG. 1A is hidden under “scraping field”. In FIG. 1A this area is coated with an opaque coating or film which must be scraped away by the purchaser before the concealed code appears. An example of such a code is shown in FIG. 1B, where the code is 1234 5678 EFGH. There is also space for advertisements on the card, example given for places of purchase for the card and web sites on Internet where the card can be used as payment means. The activation code may also be arranged on the front side of the card. An alternative to an activation code is also that the card comes preactivated to the point of purchase. This can be an alternative for points of purchase which do not have an online card reader. Point of purchase can example given be kiosks, petrol stations and grocery shops.

The concealed code on the card represents a password which the buyer of the card must use when buying goods and services online at service offerors which are connected to this form of payment. This may example given be online newspapers, tipping, online trading places, online ticket booking etc. The password is associated with the card, and the card with belonging password can be used several times until the whole amount on the card has been spent. If one is to shop more, one must buy a new card. It is also possible to use several cards in a transaction if the goods or services cost more than the amount which is printed on the card or which remains on the account belonging to the card.

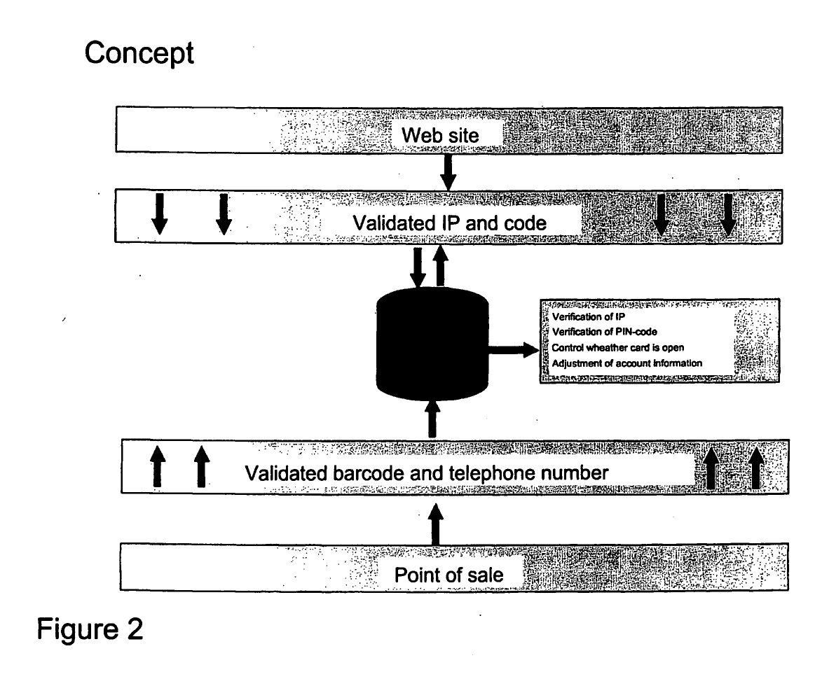

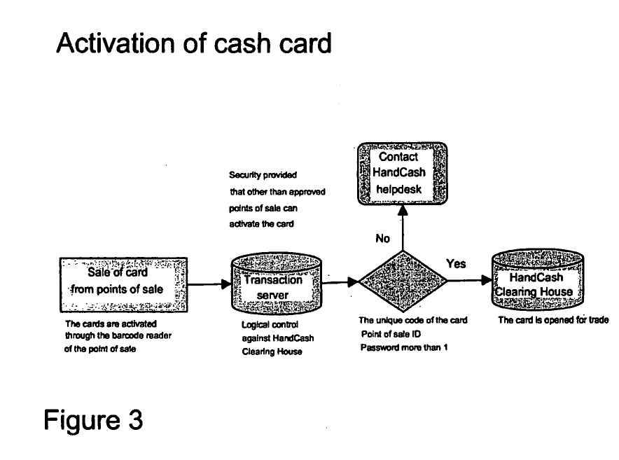

The concept for the trade solution is sketched in FIG. 2. In FIG. 2 it is used a card with a bar code. Other solutions can as mentioned above also be used. An approved point of sale for the prepaid paying cards sells the card to a purchaser. The card must thereafter be activated, and this is done by reading of the card in the bar code reader at the point of purchase. The unique bar code together with the ID of the point of sale are transmitted to the central system of the card offeror for verification. It is only registered point of sales which can distribute the prepaid paying cards. Each point of sale is therefore registered in a central database at the card offeror together with information concerning the identity of the point of sale, i.e. ID. ID may be the telephone number of the point of sale or the IP-address of the point of sale and an assigned password for the point of sale. This activation procedure is shown as a flow chart in FIG. 3.

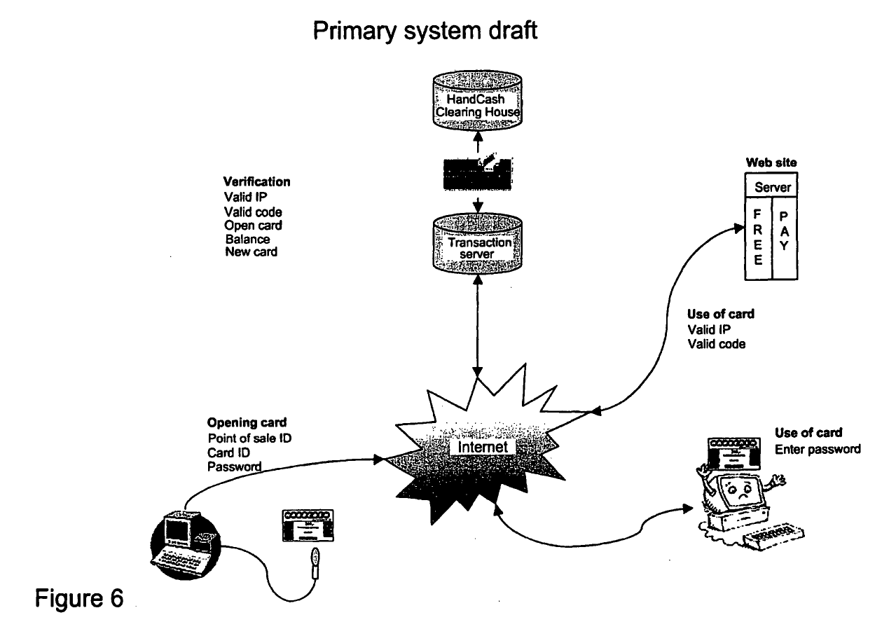

The central system in the payment system comprises a transaction server and a database server which is shown in the system sketched in FIG. 6. Between a transaction server and a database server it is as shown a firewall for securing the information existing in the database. The transaction server controls all the necessary procedures in the system and performs logic control of the information which are transmitted from point of sales and service providers by communicating with the database. If the ID of the point of sale and activation code exist in the database, the card is opened for use and a virtual account is created on the database server. The account is open for trade until the whole amount has been spent.

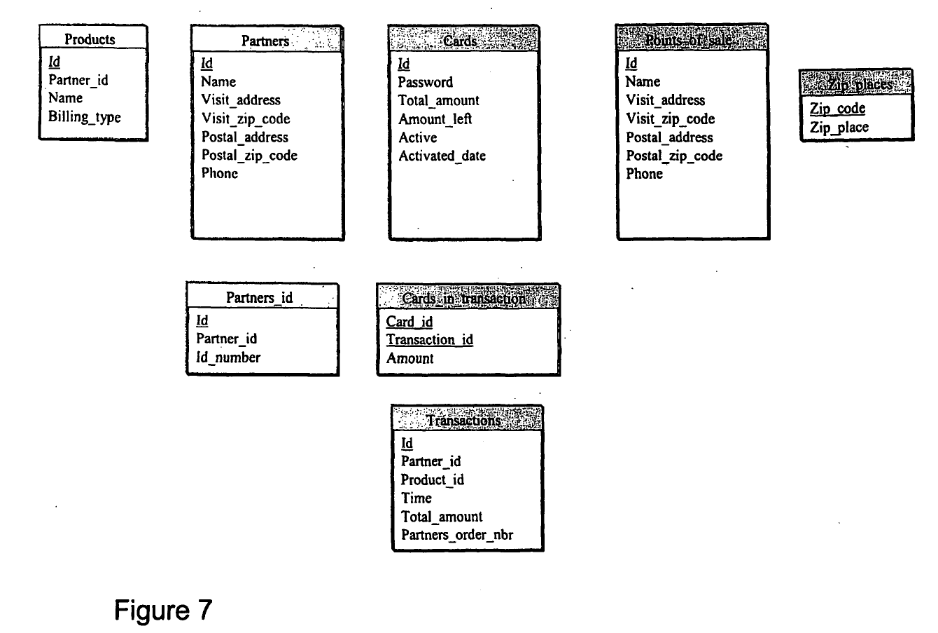

An overview over the different tables which may exist in the database stored on the database server is shown in FIG. 7. The database has a table over the cards, where each entry in the table among other things comprises information concerning the concealed code, the activation code, whether the card has been activated and when, and the balance of the account pertaining to the card. There also exists a table with necessary information about point of sales and service providers (among other things name, address, telephone number) with belonging ID and password. Information about transactions (among other things used ID, product, time, amount, trading place) and the number of cards involved in transactions are also stored. This information may be used in the settlement with the trading places and are also stored in time as a security for the actors involved.

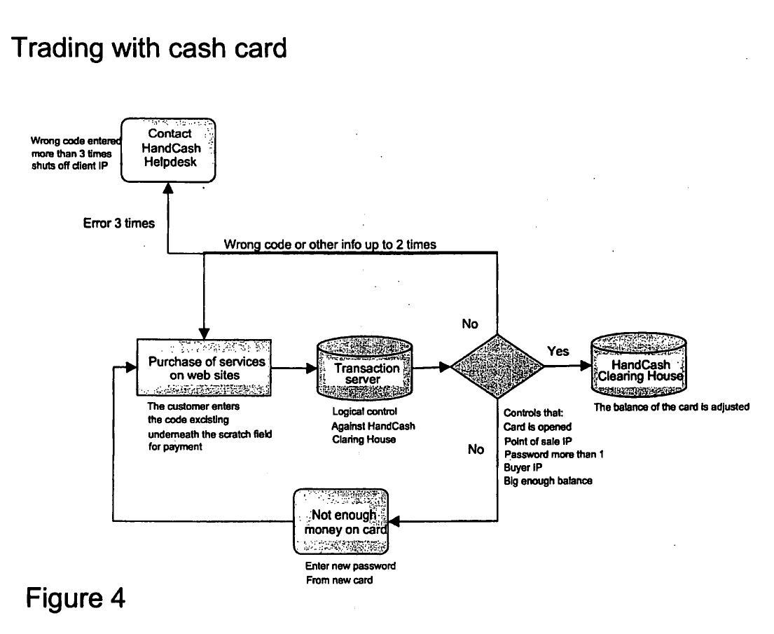

The card can also be used for payment of goods and services when shopping on example given the Internet. An example on a payment solution is shown in FIG. 4. When a user of the card is to pay for a commodity or service on a web site on Internet, the user only needs to quote the concealed code which has been obtained from the card. This code will then be transmitted, via the web site offering the commodity/service, to the card offerors central system for verification. In addition to the code information concerning the IP-address of the user, the IP-address of the web site and password are also transmitted. If the password for the web site and the concealed code comes together with valid IP for the web site to the transaction server, and the card is registered as activated and the balance of the card is greater than desired amount, it will be performed an adjustment of the balance for this card in the database stored on the database server, corresponding to the amount which the customer shall pay for the commodity/service desired from the web site. If the balance is not adequate to pay for the commodity/service, the user receives a message that a new card can be used. In this way several cards can be used together to pay for a commodity/service. If a user of the card provides the wrong code more than three times, this user's IP will be closed for use. The card will be closed for use if there occur errors in one of the passwords or other necessary information more than twice.

A password for a trading place is generated every day by the transaction server in the central system of the card offeror, stored in the database on the database server, and entered into the trading place systems automatically without the trading place “seeing” this. A trading place can be allocated more than one password and which password to be used in connection with a payment transaction is then arbitrary. This provides increased security in the system.

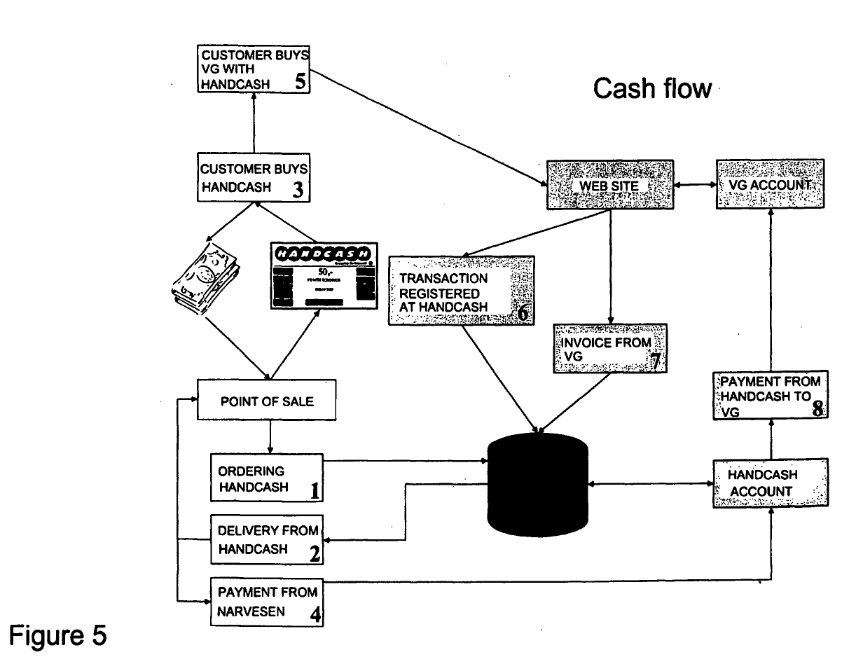

The cash flow in this payment system among the different actors is shown in FIG. 5. Points of sale for the card buys the payment cards from the card offeror and sells the cards to the users of the online trading places. When a user buys a commodity or a service (also includes content) electronically, the transaction is registered in the database at the card offeror. The online trading place where the user has used the card as means of payment for goods/commodity, sends a collective invoice to the card offeror. This invoice is controlled against the account information in the database of the card offeror, and which pays out the amount to the online trading places' account. The whole process can take place electronically.

An example of a system for a payment solution with a prepaid card is shown in FIG. 6. Here, the different actors in the system are connected via Internet, and all the interfaces in the different systems are then adapted to this. In this case the bar code reader at the point of sale for the card is connected to Internet via a PC. Both analogue and digital connection solutions are possible. The online trading places exist in FIG. 6 on Internet, and the user can buy goods and services in these by using a regular PC for home use and the prepaid card. The only thing the user is supposed to do after having chosen the commodity/service, is to state the concealed code on the card to the online trading place. The user's IP-address will be transmitted to the card offeror's central system automatically, together with the other necessary information from the electronic trading place. The transaction server communicates with Internet via a TCP/IP interface. The database server in the central systems is protected with an appropriate firewall. The communication which takes place on Internet among the different actors in the system is in encrypted form.

The card may also be used in payment solutions where the user communicates with a service provider via mobile phone (WAP) or another hand held electronic communication device. All the user has to do is to provide the concealed code on the card to the service provider, which then communicates this to the card offeror's system.

1. Method for payment of goods and/or services by using a prepaid card, where the card comprises a concealed code and an activation code, where the method comprises:
to activate the card at a point of sale for the card by reading the activation code in a card reader on the point of sale, and where the activation code is transmitted to an offeror of the prepaid card together with and ID for the point of sale, and
when paying for goods/services from a service provider, to transmit the concealed code together with the ID for the service provider to the card offeror for thereby causing purchase of the goods/service.

2. Method according to claim 1,
characterized in that the activation of the card causes opening of an account for a buyer of the card at the card offeror, with an amount corresponding to the prepaid amount.

3. Method according to claim 1,
characterized in that the activation code is a bar code and that the card is read in a bar code reader.

4. Method according to claim 1,
characterized in that the concealed code is covered by a thin opaque layer which must be scraped off by the buyer of the card.

5. Method according to claim 1 or 2,
characterized in that the card offeror controls that the card is activated, authenticates the concealed code and the ID of the service provider, and controls that the balance of the account is bigger or equal to the cost for purchase of the service, before purchase of the service can take place.

6. Method according to claim 4,
characterized in that control and authenticating take place by query against the card offeror's database stored on a database server communicating with the transaction server.

7. Method according to claim 1,
characterized in that the ID of the service provider is an IP-address and at least one unique password.

8. Method according to claim 1,
characterized in that ID for the point of sale is the phone number of the point of sale and a unique password for the point of sale, and that the point of sale communicates with the central systems via the telephone network and/or Internet.

9. System for prepayment of goods and services comprising a prepaid card, where the card comprises a concealed code to be used by a purchaser of the card for authenticating when purchasing goods and/or services, and an activation code, where the system further comprises:
a card reader for reading of the activation code of the card at a point of sale for the card, and where the activation code is transmitted to a central system for an offeror of the prepaid card together with an ID for the point of sale; and
an electronic service provider, where the service provider transmits the concealed code from a purchaser of a service at a service provider together with the ID of the service provider, to the central system of the card offeror for thereby causing payment of the service from the service provider.

10. System according to claim 9,
characterized in that the activation code is a bar code, the card reader is a bar code reader, and ID for the point of sale is the point of sale's telephone number and a unique password.

11. System according to claim 9,
characterized in that the service provider is a web site on Internet and that the ID of the service provider is the IP-address of the web site and at least one unique password for the service provider.

12. System according to claim 9,
characterized in that the central systems comprise a transaction server which has stored thereon functions for logic and procedures, a database server comprising a database with data for the prepaid cards, point of sales and service providers, and a firewall between the transaction server and the database server, and where queries against the database are controlled by the transaction server.

12. System according to claim 9,
characterized in that the database comprises a table stored for all cards, where a record for each card comprises the concealed code, the activation code, if the card is activated and the balance of the account belonging to the card, and a table for point of sales and service providers with pertaining ID.

13. System according to claim 9,
characterized in that the card reader is connected to a PC which further is connected to Internet.

14. System according to claim 11,
characterized in that the user communicates with a service provider via a PC, mobile phone, or another electronic communication device.
